(19) United States
(12) Patent Application Publication
(10) Pub. No.: US 2019/0278518 A1
(43) Pub. Date: Sep. 12, 2019

(54) MEMORY SYSTEM AND OPERATING METHOD THEREOF

(71) Applicant: SK hynix Inc., Gyeonggi-do (KR)

(72) Inventors: Eu-Joon BYUN, Gyeonggi-do (KR); Kyeong-Rho KIM, Gyeonggi-do (KR)

(21) Appl. No.: 16/176,895

(22) Filed: Oct. 31, 2018

(30) Foreign Application Priority Data
Mar. 8, 2018 (KR) 10-2018-0027404

(51) Int. Cl. G06F 3/06; G06F 12/02; G06F 12/1009

(52) U.S. Cl. CPC G06F 3/0659; G06F 3/0631; G06F 3/064; G06F 12/0246; G06F 2212/7202; G06F 3/0679; G06F 3/061; G06F 2212/7201; G06F 12/1009

(57) ABSTRACT

A memory system may include: a memory device including a plurality of pages in which data are stored and a plurality of memory blocks in which the pages are included; and a controller including a first memory, the controller may check operations to be performed in the memory blocks, may schedule queues corresponding to the operations, allocates the first memory and a second memory included in a host to memory regions corresponding to the scheduled queues, may perform the operations through the memory regions allocated in the first memory and the second memory, and may record information on the operations, the queues and the memory regions in a table.

### CROSS-REFERENCE TO RELATED APPLICATION

This application claims priority under 35 U.S.C. § 119 to Korean Patent Application No. 10-2018-0027404 filed on Mar. 8, 2018, which is incorporated herein by reference in its entirety.

### BACKGROUND

### 1. Field

Various embodiments of the present invention generally relate to a memory system. Particularly, the embodiments relate to a memory system which uses a host-side memory device for scheduling operations performed onto a memory device, and an operating method thereof.

### 2. Discussion of the Related Art

The computer environment paradigm has changed to ubiquitous computing systems that allows computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main or an auxiliary storage device of a portable electronic device.

Memory systems provide excellent stability, durability, high information access speed, and low power consumption because they have no moving parts (e.g., a mechanical arm with a read/write head) as compared with a hard disk device. Examples of memory systems having such advantages include universal serial bus (USB) memory devices, memory cards having various interfaces, and solid state drives (SSD).

### SUMMARY

Various embodiments are directed to a memory system and an operating method thereof, capable of reducing or minimizing complexity and performance deterioration of a memory system and enhancing or maximizing utilization efficiency of a memory device, thereby quickly and stably processing data with respect to the memory device.

In an embodiment, a memory system may include: a memory device including a plurality of pages in which data are stored and a plurality of memory blocks in which the pages are included; and a controller including a first memory, the controller may check operations to be performed in the memory blocks, may schedule queues corresponding to the operations, allocates the first memory and a second memory included in a host to memory regions corresponding to the scheduled queues, may perform the operations through the memory regions allocated in the first memory and the second memory, and may record information on the operations, the queues and the memory regions in a table.

The controller may record, after assigning identifiers for the operations, the respective identifiers in the table.

The controller may record, after assigning virtual address to the queues, respective indexes for the queues in the table.

The controller may record addresses of the memory regions allocated to the first memory and the second memory, in the table, and maps the virtual addresses and the addresses of the memory regions.

The controller may convert, when accessing the queues through the virtual addresses, the virtual addresses into the addresses of the memory regions.

The controller may check host data in correspondence to performing of the operations, and may transmit a response message which includes an indication information of the host data, to the host, and the indication information may include an information on a type of the host data and an information on a size of the host data.

The host may check the indication information included in the response message, may allocate a memory region for the host data, to the second memory, in correspondence to the indication information, and may transmit a read command for the host data, to the controller.

The controller may transmit the host data to the host as a response to the read command, and the host data may include at least one of user data and map data in correspondence to performing of the operations, and may be stored in the memory region of the host data which is allocated to the second memory.

The controller may assign an identifier for transmission and storage of the host data, may store the identifier in the table, may schedule a host data queue corresponding to the host data, may record an index for the host data queue, in the table, may check an address for the memory region of the host data, allocated to the second memory, and may record the address for the memory region of the host data, in the table.

The controller may update the host data, may transmit an update message for the host data, to the host, and may transmit updated host data to the host after receiving the read command from the host in correspondence to the update message.

In an embodiment, a method for operating a memory system, may include: checking, for a memory device including a plurality of pages in which data are stored and a plurality of memory blocks in which the pages are included, operations to be performed in the memory blocks; scheduling queues corresponding to the operations; allocating a first memory included in a controller and a second memory included in a host to memory regions corresponding to the scheduled queues; performing the operations through the memory regions allocated in the first memory and the second memory; and recording information on the operations, the queues and the memory regions in a table.

The recording may include: recording, after assigning identifiers for the operations, the respective identifiers in the table.

The recording may include: recording, after assigning virtual address to the queues, respective indexes for the queues in the table.

The recording may include: recording addresses of the memory regions allocated to the first memory and the second memory, in the table.

The method may further include: mapping the virtual addresses and the addresses of the memory regions; and converting, when accessing the queues through the virtual addresses, the virtual addresses into the addresses of the memory regions.

The method may further include: checking host data in correspondence to performing of the operations; and transmitting a response message which includes an indication information of the host data, to the host.

The method may further include: receiving, after a memory region for the host data is allocated to the second memory, in correspondence to the indication information included in the response message, a read command for the host data, from the host; and transmitting the host data to the host as a response to the read command.

The memory region for the host data may be allocated to the second memory by the host, the indication information may include an information on a type of the host data and an information on a size of the host data, and the host data may include at least one of user data and map data in correspondence to performing of the operations, and may be stored in the memory region of the host data which is allocated to the second memory.

The recording may include: assigning an identifier for transmission and storage of the host data, and storing the identifier in the table; scheduling a host data queue corresponding to the host data, and recording an index for the host data queue, in the table;

and checking an address for the memory region of the host data, allocated to the second memory, and recording the address for the memory region of the host data, in the table.

The method may further include: updating the host data, and transmitting an update message for the host data, to the host; and transmitting updated host data to the host after receiving the read command from the host in correspondence to the update message.

In an embodiment, a memory system may include: a memory device including a plurality of memory blocks, each including a plurality of pages; and a controller including a first memory to carry out a plurality of operations onto the plurality of memory blocks, the controller may generate queues, each corresponding to the plurality of operations, may allocate the queues to the first memory and a second memory included in a host, may use the queues to perform the plurality of operations, and may generate a table including information on the plurality of operations, the queues and usage of the first memory and the second memory.

### BRIEF DESCRIPTION OF THE DRAWINGS

These and other features and advantages of the present invention will become apparent to those skilled in the art to which the present invention pertains from the following detailed description in reference to the accompanying drawings, wherein:

FIG. 1 is a block diagram illustrating a data processing system including a memory system in accordance with an embodiment of the present invention;

FIG. 2 is a schematic diagram illustrating a configuration of a memory device employed in the memory system shown in FIG. 1;

FIG. 3 is a circuit diagram illustrating a configuration of a memory cell array of a memory block in the memory device shown in FIG. 2;

FIG. 4 is a schematic diagram illustrating an exemplary three-dimensional structure of the memory device shown in FIG. 2;

FIGS. 5 to 8 are schematic diagrams describing a data processing operation when performing a foreground operation and a background operation for a memory device in a memory system in accordance with an embodiment;

FIG. 9 is a flow chart describing an operation process for processing data in a memory system in accordance with an embodiment; and

FIGS. 10 to 18 are diagrams schematically illustrating application examples of the data processing system shown in FIG. 1 in accordance with various embodiments of the present invention.

### DETAILED DESCRIPTION

Various embodiments of the present invention are described below in more detail with reference to the accompanying drawings.

We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention. It is noted that reference to “an embodiment” does not necessarily mean only one embodiment, and different references to “an embodiment” are not necessarily to the same embodiment(s).

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for describing particular embodiments only and is not intended to be limiting of the present invention. As used herein, singular forms are intended to include the plural forms and vice versa, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

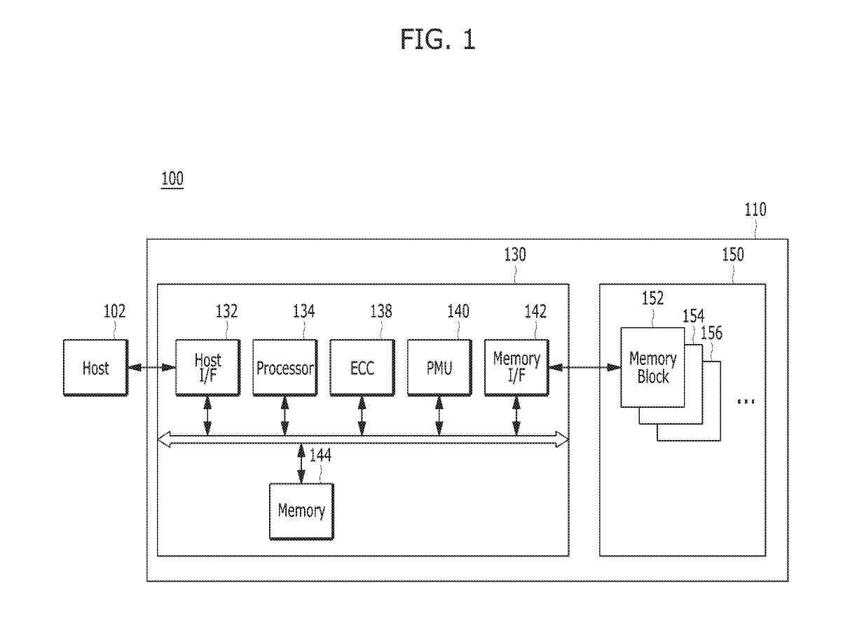

FIG. 1 is a block diagram illustrating a data processing system 100 including a memory system 110 in accordance with an embodiment of the present invention.

Referring to FIG. 1, the data processing system 100 may include a host 102 and the memory system 110.

The host 102 may include portable electronic devices such as a mobile phone, MP3 player and laptop computer or non-portable electronic devices such as a desktop computer, a game machine, a TV and a projector.

The memory system 110 may operate to store data for the host 102 in response to a request of the host 102. Non-limiting examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC. The SD card may include a mini-SD card and micro-SD card.

The memory system 110 may be embodied by various types of storage devices. Non-limiting examples of storage devices included in the memory system 110 may include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM) and a flash memory. The flash memory may have a 3-dimensional (3D) stack structure.

The memory system 110 may include a memory device 150 and a controller 130. The memory device 150 may store data for the host 120. The controller 130 may control data storage into the memory device 150.

The controller 130 and the memory device 150 may be integrated into a single semiconductor device, which may be included in the various types of memory systems as exemplified above.

Non-limiting application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation. The memory device 150 may provide data stored therein to the host 102 through a read operation. The memory device 150 may include a plurality of memory dies (not shown), each memory die including a plurality of planes (not shown), each plane including a plurality of memory blocks 152 to 156. Each of the memory blocks 152 to 156 may include a plurality of pages. Each of the pages may include a plurality of memory cells coupled to a word line.

The controller 130 may control the memory device 150 in response to a request from the host 102. By way of example and not limitation, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) 132, a processor 134, an error correction code (ECC) component 138, a Power Management Unit (PMU) 140, a memory interface 142 such as a NAND flash controller (NFC), and a memory 144. Each of components may be electrically coupled, or engaged with, each other via an internal bus.

The host interface 132 may be configured to process a command and data of the host 102, and may communicate with the host 102 under one or more of various interface protocols such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (DATA), enhanced small disk interface (ESDI) and integrated drive electronics (IDE).

The ECC component 138 may detect and correct an error contained in the data read from the memory device 150. In other words, the ECC component 138 may perform an error correction decoding process to the data read from the memory device 150 through an ECC code used during an ECC encoding process. According to a result of the error correction decoding process, the ECC component 138 may output a signal, for example, an error correction success or fail signal. When the number of error bits is more than a threshold value of correctable error bits, the ECC component 138 may not correct the error bits to output the error correction fail signal.

The ECC component 138 may perform error correction through a coded modulation such as Low Density Parity Check (LDDC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC component 138 is not limited thereto. The ECC component 138 may include all circuits, modules, systems or devices for error correction.

The PMU 140 may manage an electrical power used and provided in the controller 130.

The memory interface 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the memory interface 142 may generate a control signal for the memory device 150 to process data entered into the memory device 150 by the processor 134. The memory interface 142 may work as an interface (e.g., a NAND flash interface) for processing a command and data between the controller 130 and the memory device 150. Specifically, the memory interface 142 may support data transfer between the controller 130 and the memory device 150.

The memory 144 may serve as a working memory of the memory system 110 and the controller 130. The memory 144 may store data supporting operation of the memory system 110 and the controller 130. The controller 130 may control the memory device 150 so that read, write, program and erase operations are performed in response to a request from the host 102. The controller 130 may output data read from the memory device 150 to the host 102, and may store data provided from the host 102 into the memory device 150. The memory 144 may store data required for the controller 130 and the memory device 150 to perform these operations.

The memory 144 may be embodied by a volatile memory. By way of example and not limitation, the memory 144 may be embodied by static random access memory (SRAM) or dynamic random access memory (DRAM). The memory 144 may be disposed within or out of the controller 130. FIG. 1 describes an example of the memory 144 disposed within the controller 130. In another embodiment, the memory 144 may be embodied by an external volatile memory having a memory interface transferring data between the memory 144 and the controller 130.

The processor 134 may control the overall operations of the memory system 110. The processor 134 may use a firmware to control the overall operations of the memory system 110. The firmware may be referred to as flash translation layer (FTL).

For instance, the controller 130 performs an operation requested from the host 102, in the memory device 150, that is, performs a command operation corresponding to a command entered from the host 102, with the memory device 150, through the processor 134 embodied by a microprocessor or a central processing unit (CPU). The controller 130 may perform a foreground operation, including a command operation corresponding to a command received from the host 102, for example, a program operation corresponding to a write command, a read operation corresponding to a read command, an erase operation corresponding to an erase command, and a parameter set operation corresponding to a set parameter command or a set feature command as a set command.

The controller 130 may also perform a background operation for the memory device 150, through the processor 134 embodied by a microprocessor or a central processing unit (CPU). The background operation for the memory device 150 may include an operation of copying the data stored in an optional memory block among the memory blocks 152, 154, 156, . . . (hereinafter, referred to as “memory blocks 152 to 156”) of the memory device 150, to another optional memory block, for example, a garbage collection (GC) operation, an operation of swapping the memory blocks 152 to 156 of the memory device 150 or the data stored in the memory blocks 152 to 156, for example, a wear leveling (WL) operation, an operation of storing the map data stored in the controller 130, in the memory blocks 152 to 156 of the memory device 150, for example, a map flush operation, or a bad management operation for the memory device 150, for example, a bad block management operation of checking and processing bad blocks among the plurality of memory blocks 152 to 156 included in the memory device 150.

In a memory system in accordance with an embodiment of the present disclosure, for instance, the controller 130 performs a plurality of command operations corresponding to a plurality of commands received from the host 102, in the memory device 150. For example, the controller 130 performs, onto the memory device 150, a plurality of program operations corresponding to a plurality of write commands, a plurality of read operations corresponding to a plurality of read commands and a plurality of erase operations corresponding to a plurality of erase commands. In correspondence to performing the plurality of command operations, the controller 130 updates metadata, in particular, map data.

In the memory system in accordance with the embodiment of the present disclosure, when performing command operations corresponding to a plurality of commands entered from the host 102, for example, program operations, read operations and erase operations, in the plurality of memory blocks included in the memory device 150, the controller 130 may use queues to schedule plural operations corresponding to plural commands. The controller 130 may split the memory 144 into plural memory regions to allocate or assign the memory regions for the scheduled queues, to the memory 144 included in the controller 130 and the memory included in the host 102. Further, in the memory system in accordance with the embodiment of the present disclosure, as described above, when performing not only foreground operations including command operations but also background operations, for example, a garbage collection operation or a read reclaim operation as a copy operation, a wear leveling operation as a swap operation and a map flush operation, the controller 130 may schedule queues corresponding to the background operations. The controller 130 may allocate memory regions corresponding to the scheduled queues, plural memory regions of the memory 144 included in the controller 130 and the memory included in the host 102.

In the memory system in accordance with the embodiment of the disclosure, when performing a foreground operation and a background operation for the memory device 150, plural queues corresponding to the foreground operation and the background operation are scheduled and are allocated in the memory 144 of the controller 130 and the memory included in the host 102. Particularly, identifiers (IDs) are assigned by respective operations. Plural queues, each including operations assigned with the respective identifiers, may be scheduled. In the memory system in accordance with another embodiment of the disclosure, identifiers are assigned not only to respective operations for the memory device 150 but also to functions carried out onto the memory device 150. Plural queues, each including the functions assigned with the respective identifiers, may be scheduled.

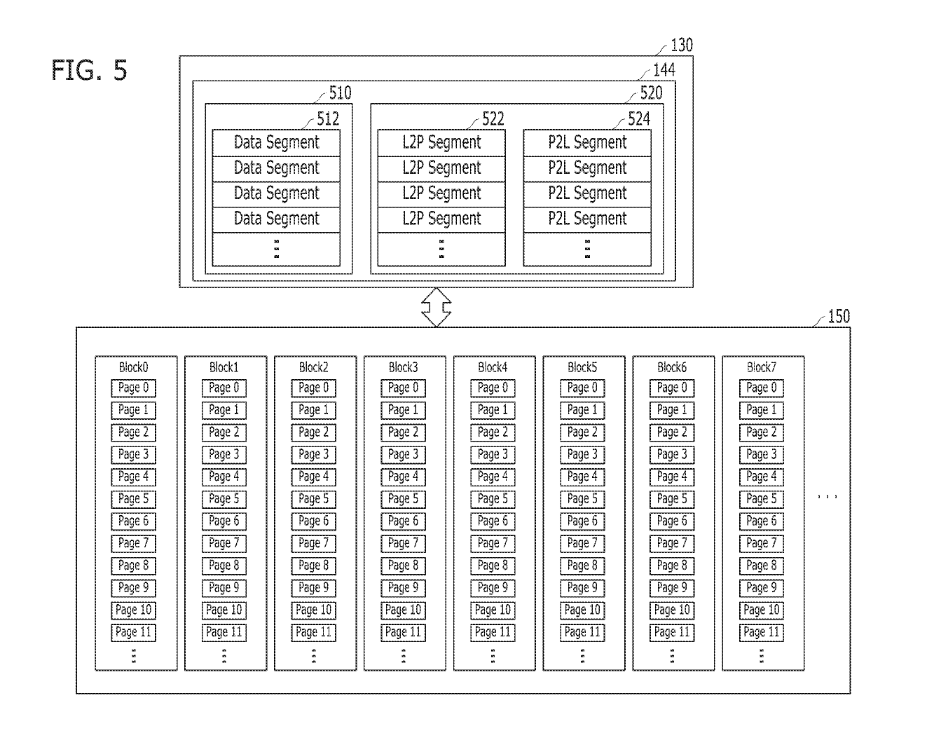

In the memory system in accordance with the embodiment of the disclosure, queues may be scheduled by the identifiers of respective functions and operations to be performed in the memory device 150, which are managed or controlled by the controller 130. Particularly, queues scheduled by the identifiers of a foreground operation and a background operation to be performed in the memory device 150 may be managed. In the memory system in accordance with the embodiment of the present disclosure, after memory regions of the memory 144 included in the controller 130 and the memory included in the host 102 are allocated corresponding to the queues scheduled by identifiers. Addresses for the allocated memory regions can be separately stored and managed by the controller 130. Not only the foreground operation and the background operation but also respective functions and operations are performed in the memory device 150, by using the scheduled queues. In the memory system in accordance with the embodiment of the present disclosure, since detailed descriptions will be made below with reference to FIGS. 5 to 9 for performing of a foreground operation and a background operation as functions and operations for the memory device 150 and for scheduling of respective corresponding queues and allocating for the respective queue memory regions of the memory 144 of the controller 130 and the memory of the host 102 to perform the foreground operation and the background operation, further descriptions thereof will be omitted herein.

The processor 134 of the controller 130 may include a management unit (not illustrated) for performing a bad management operation of the memory device 150. The management unit may perform a bad block management operation of checking a bad block among the plurality of memory blocks 152 to 156 included in the memory device 150. The bad block may include a block where a program fail occurs during a program operation, due to the characteristics of a NAND flash memory. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation needs to be performed with more reliability.

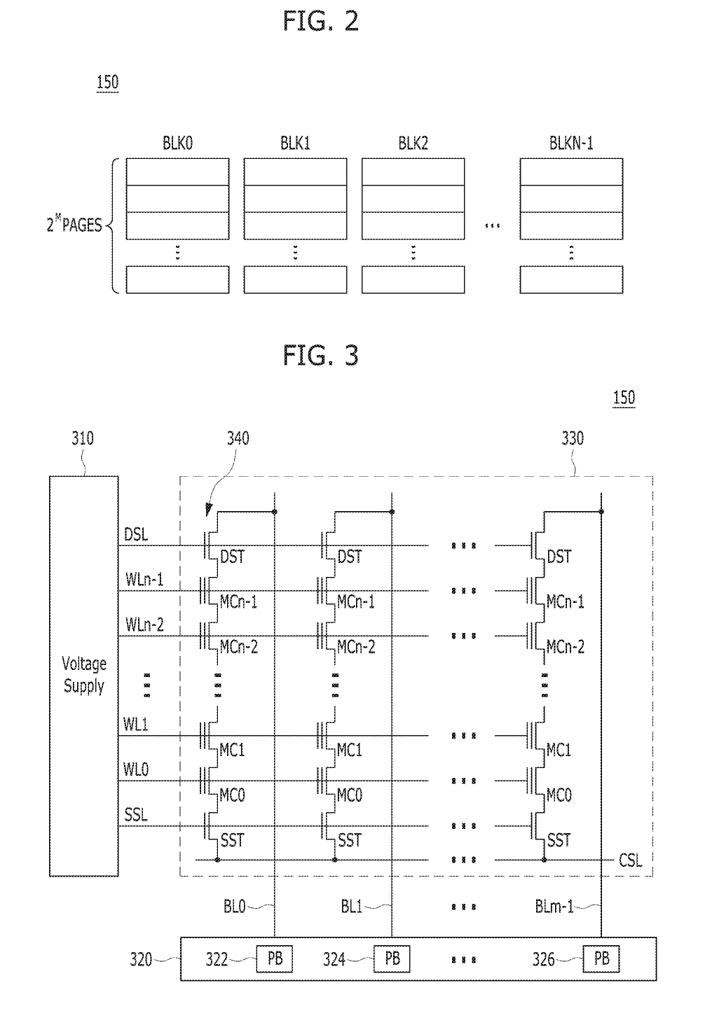

FIG. 2 is a schematic diagram illustrating the memory device 150.

Referring to FIG. 2, the memory device 150 may include a plurality of memory blocks BLK0 to BLKN−1, and each of the blocks BLK0 to BLKN−1 may include a plurality of pages, for example, 2′¹ pages, the number of which may vary according to circuit design. Memory cells included in the respective memory blocks BLK0 to BLKN−1 may be one or more of a single level cell (SLC) storing 1-bit data, or a multi-level cell (MLC) storing 2- or more bit data. In an embodiment, the memory device 150 may include a plurality of triple level cells (TLC) each storing 3-bit data. In another embodiment, the memory device may include a plurality of quadruple level cells (QLC) each storing 4-bit level cell.

FIG. 3 is a circuit diagram illustrating an exemplary configuration of a memory cell array of a memory block in the memory device 150.

Referring to FIG. 3, a memory block 330 which may correspond to any of the plurality of memory blocks 152 to 156 included in the memory device 150 of the memory system 110 may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST, SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1. For reference, in FIG. 3, ‘DSL’ denotes a drain select line, ‘SSL’ denotes a source select line, and ‘Ca’ denotes a common source line. A plurality of world lines WL0 to WLn−1 may be coupled in series between the select source line SSL and the drain source line DSL.

Although FIG. 3 illustrates NAND flash memory cells, the present invention is not limited thereto. That is, it is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under the control of the control circuit, the voltage supply 310 may select one of the memory blocks (or sectors) of the memory cell array, select one of the word lines of the selected memory block, and provide the word line voltages to the selected word line and the unselected word lines as may be needed.

The memory device 150 may include a read and write (read/write) circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and may supply a current or a voltage onto bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

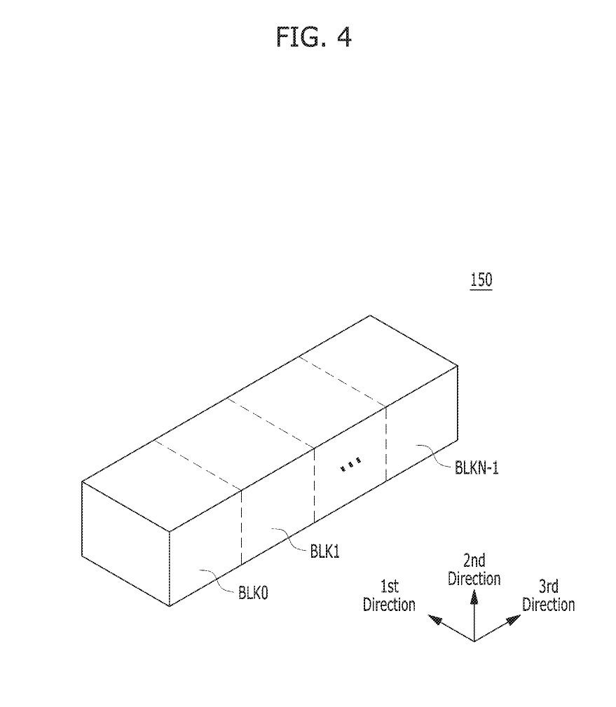

FIG. 4 is a schematic diagram illustrating an exemplary 3D structure of the memory device 150.

The memory device 150 may be embodied by a two-dimensional (2D) or three-dimensional (3D) memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1 each having a 3D structure (or vertical structure).

Hereinbelow, detailed descriptions will be made with reference to FIGS. 5 to 9 for a data processing operation with respect to the memory device 150 in the memory system in accordance with the embodiment of the present disclosure. Particularly, a data processing operation when performing, for example, command operations corresponding to the plurality of commands received from the host 102, as foreground operations for the memory device 150, or performing, for example, a copy operation, a swap operation and a map flush operation, as background operations for the memory device 150.

FIGS. 5 to 8 are schematic diagrams describing a data processing operation when performing a foreground operation and a background operation for a memory device in a memory system in accordance with an embodiment. In the embodiment of the present disclosure, detailed descriptions will be made by taking as an example a case where foreground operations for the memory device 150, for example, a plurality of command operations corresponding to the plurality of commands received from the host 102, are performed and background operations for the memory device 150, for example, a garbage collection operation or a read reclaim operation as a copy operation, a wear leveling operation as a swap operation and a map flush operation, are performed. Particularly, in the embodiment of the present disclosure, for the sake of convenience in explanation, detailed descriptions will be made by taking as an example a case where, in the memory system 110 shown in FIG. 1, a plurality of commands are received from the host 102 and command operations corresponding to the commands are performed. For example, in the embodiment of the disclosure, detailed descriptions will be made for a data processing operation in a case where a plurality of write commands are received from the host 102 and program operations corresponding to the write commands are performed, in another case where a plurality of read commands are received from the host 102 and read operations corresponding to the read commands are performed, in another case where a plurality of erase commands are received from the host 102 and erase operations corresponding to the erase commands are performed, or in another case where a plurality of write commands and a plurality of read commands are received together from the host 102 and program operations and read operations corresponding to the write commands and the read commands are performed.

Moreover, in the embodiment of the present disclosure, descriptions will be made by taking as an example a case where: write data corresponding to a plurality of write commands entered from the host 102 are stored in the buffer/cache included in the memory 144 of the controller 130, the write data stored in the buffer/cache are programmed to and stored in the plurality of memory blocks included in the memory device 150, map data are updated in correspondence to the stored write data in the plurality of memory blocks, and the updated map data are stored in the plurality of memory blocks included in the memory device 150. In the embodiment of the disclosure, descriptions will be made by taking as an example a case where program operations corresponding to a plurality of write commands entered from the host 102 are performed. Furthermore, in the embodiment of the disclosure, descriptions will be made by taking as an example a case where: a plurality of read commands are entered from the host 102 for the data stored in the memory device 150, data corresponding to the read commands are read from the memory device 150 by checking the map data of the data corresponding to the read commands, the read data are stored in the buffer/cache included in the memory 144 of the controller 130, and the data stored in the buffer/cache are provided to the host 102. In other words, in the embodiment of the present disclosure, descriptions will be made by taking as an example a case where read operations corresponding to a plurality of read commands entered from the host 102 are performed. In addition, in the embodiment of the disclosure, descriptions will be made by taking as an example a case where: a plurality of erase commands are received from the host 102 for the memory blocks included in the memory device 150, memory blocks are checked corresponding to the erase commands, the data stored in the checked memory blocks are erased, map data are updated in correspondence to the erased data, and the updated map data are stored in the plurality of memory blocks included in the memory device 150. Namely, in the embodiment of the present disclosure, descriptions will be made by taking as an example a case where erase operations corresponding to a plurality of erase commands received from the host 102 are performed.

Further, although it is described as an example, for the sake of convenience in explanation, that the controller 130 performs command operations in the memory system 110, it is to be noted that, as described above, the processor 134 included in the controller 130 may perform command operations in the memory system 110, through, for example, an FTL (flash translation layer). Also, in the embodiment of the present disclosure, the controller 130 programs and stores user data and metadata corresponding to write commands entered from the host 102, in arbitrary memory blocks among the plurality of memory blocks included in the memory device 150, reads user data and metadata corresponding to read commands received from the host 102, from arbitrary memory blocks among the plurality of memory blocks included in the memory device 150, and provides the read data to the host 102, or erases user data and metadata, corresponding to erase commands entered from the host 102, from arbitrary memory blocks among the plurality of memory blocks included in the memory device 150.

Metadata may include first map data including a logical to physical (L2P) information (hereinafter, referred to as a ‘logical information’) and second map data including a physical to logical (P2L) information (hereinafter, referred to as a ‘physical information’), for data stored in memory blocks in correspondence to a program operation. Also, the metadata may include an information on command data corresponding to a command received from the host 102, an information on a command operation corresponding to the command, an information on the memory blocks of the memory device 150 for which the command operation is to be performed, and an information on map data corresponding to the command operation. In other words, metadata may include all remaining information and data excluding user data corresponding to a command received from the host 102.

That is, in the embodiment of the disclosure, in the case where the controller 130 receives a plurality of write commands from the host 102, program operations corresponding to the write commands are performed, and user data corresponding to the write commands are written and stored in empty memory blocks, open memory blocks, or free memory blocks for which an erase operation has been performed among the memory blocks of the memory device 150. Also, first map data, including an L2P map table or an L2P map list in which logical information as the mapping information between logical addresses and physical addresses for the user data stored in the memory blocks are recorded, and second map data, including a P2L map table or a P2L map list in which physical information as the mapping information between physical addresses and logical addresses for the memory blocks stored with the user data are recorded, are written and stored in empty memory blocks, open memory blocks or free memory blocks among the memory blocks of the memory device 150.

Here, in the case where write commands are entered from the host 102, the controller 130 writes and stores user data corresponding to the write commands in memory blocks. The controller 130 stores, in other memory blocks, metadata including first map data and second map data for the user data stored in the memory blocks. Particularly, in correspondence to that the data segments of the user data are stored in the memory blocks of the memory device 150, the controller 130 generates and updates the L2P segments of first map data and the P2L segments of second map data as the map segments of map data among the meta segments of metadata. The controller 130 stores them in the memory blocks of the memory device 150. The map segments stored in the memory blocks of the memory device 150 are loaded in the memory 144 included in the controller 130 and are then updated.

Further, in the case where a plurality of read commands are received from the host 102, the controller 130 reads read data corresponding to the read commands, from the memory device 150, and stores the read data in the buffers/caches included in the memory 144 of the controller 130. The controller 130 provides the data stored in the buffers/caches, to the host 102, by which read operations corresponding to the plurality of read commands are performed.

In addition, in the case where a plurality of erase commands are received from the host 102, the controller 130 checks memory blocks of the memory device 150 corresponding to the erase commands, and then, performs erase operations for the memory blocks.

When command operations corresponding to the plurality of commands received from the host 102 are performed while a background operation is performed, the controller 130 loads and stores data corresponding to the background operation, that metadata and user data, in the buffer/cache included in the memory 144 of the controller 130, and then stores the data, that is, the metadata and the user data, in the memory device 150. Herein, by way of example and not limitation, the background operation may include a garbage collection operation or a read reclaim operation as a copy operation, a wear leveling operation as a swap operation or a map flush operation, For instance, for the background operation, the controller 130 may check metadata and user data corresponding to the background operation, in the memory blocks of the memory device 150, load and store the metadata and user data stored in certain memory blocks of the memory device 150, in the buffer/cache included in the memory 144 of the controller 130, and then store the metadata and user data, in certain other memory blocks of the memory device 150.

In the memory system in accordance with the embodiment of the present disclosure, when performing command operations as foreground operations and a copy operation, a swap operation and a map flush operation as background operations, the controller 130 schedules queues corresponding to the foreground operations and the background operations and allocates the scheduled queues to the memory 144 included in the controller 130 and the memory included in the host 102. In this regard, the controller 130 assigns identifiers (IDs) by respective operations for the foreground operations and the background operations to be performed in the memory device 150, and schedules queues corresponding to the operations assigned with the identifiers, respectively. In the memory system in accordance with the embodiment of the present disclosure, identifiers are assigned not only by respective operations for the memory device 150 but also by functions for the memory device 150, and queues corresponding to the functions assigned with respective identifiers are scheduled.

In the memory system in accordance with the embodiment of the present disclosure, the controller 130 manages the queues scheduled by the identifiers of respective functions and operations to be performed in the memory device 150. The controller 130 manages the queues scheduled by the identifiers of a foreground operation and a background operation to be performed in the memory device 150. In the memory system in accordance with the embodiment of the present disclosure, after memory regions corresponding to the queues scheduled by identifiers are allocated to the memory 144 included in the controller 130 and the memory included in the host 102, the controller 130 manages addresses for the allocated memory regions. The controller 130 performs not only the foreground operation and the background operation but also respective functions and operations in the memory device 150, by using the scheduled queues. Hereinbelow, a data processing operation in the memory system in accordance with the embodiment of the present disclosure will be described in detail with reference to FIGS. 5 to 8.

Referring to FIG. 5, the controller 130 performs command operations corresponding to a plurality of commands entered from the host 102, for example, program operations corresponding to a plurality of write commands entered from the host 102. At this time, the controller 130 programs and stores user data corresponding to the write commands, in memory blocks of the memory device 150. Also, in correspondence to the program operations with respect to the memory blocks, the controller 130 generates and updates metadata for the user data and stores the metadata in the memory blocks of the memory device 150.

The controller 130 generates and updates first map data and second map data which include information indicating that the user data are stored in pages included in the memory blocks of the memory device 150. That is, the controller 130 generates and updates L2P segments as the logical segments of the first map data and P2L segments as the physical segments of the second map data, and then stores them in pages included in the memory blocks of the memory device 150.

For example, the controller 130 caches and buffers the user data corresponding to the write commands entered from the host 102, in a first buffer 510 included in the memory 144 of the controller 130. Particularly, after storing data segments 512 of the user data in the first buffer 510 that is used as a data buffer/cache, the controller 130 stores the data segments 512 stored in the first buffer 510 in pages included in the memory blocks of the memory device 150. As the data segments 512 of the user data corresponding to the write commands received from the host 102 are programmed to and stored in the pages included in the memory blocks of the memory device 150, the controller 130 generates and updates the first map data and the second map data. The controller 130 stores them in a second buffer 520 included in the memory 144 of the controller 130. Particularly, the controller 130 stores L2P segments 522 of the first map data and P2L segments 524 of the second map data for the user data, in the second buffer 520 as a map buffer/cache. As described above, the L2P segments 522 of the first map data and the P2L segments 524 of the second map data may be stored in the second buffer 520 of the memory 144 in the controller 130. A map list for the L2P segments 522 of the first map data and another map list for the P2L segments 524 of the second map data may be stored in the second buffer 520. The controller 130 stores the L2P segments 522 of the first map data and the P2L segments 524 of the second map data, which are stored in the second buffer 520, in pages included in the memory blocks of the memory device 150.

Also, the controller 130 performs command operations corresponding to a plurality of commands received from the host 102, for example, read operations corresponding to a plurality of read commands received from the host 102. Particularly, the controller 130 loads L2P segments 522 of first map data and P2L segments 524 of second map data as the map segments of user data corresponding to the read commands, in the second buffer 520, and checks the L2P segments 522 and the P2L segments 524. Then, the controller 130 reads the user data stored in pages of corresponding memory blocks among the memory blocks of the memory device 150, stores data segments 512 of the read user data in the first buffer 510, and then provides the data segments 512 to the host 102.

Furthermore, the controller 130 performs command operations corresponding to a plurality of commands entered from the host 102, for example, erase operations corresponding to a plurality of erase commands entered from the host 102. In particular, the controller 130 checks memory blocks corresponding to the erase commands among the memory blocks of the memory device 150 to carry out the erase operations for the checked memory blocks.

When performing an operation of copying data or swapping data among the memory blocks included in the memory device 150, for example, a garbage collection operation, a read reclaim operation or a wear leveling operation, as a background operation, the controller 130 stores data segments 512 of corresponding user data, in the first buffer 510, loads map segments 522 and 524 of map data corresponding to the user data in the second buffer 520, and then performs the garbage collection operation, the read reclaim operation, or the wear leveling operation. When performing a map update operation and a map flush operation for metadata, e.g., map data, for the memory blocks of the memory device 150 as a background operation, the controller 130 loads the corresponding map segments 522 and 524 in the second buffer 520, and then performs the map update operation and the map flush operation.

As mentioned above, when performing functions and operations including a foreground operation and a background operation for the memory device 150, the controller 130 assigns identifiers by the functions and operations to be performed for the memory device 150. The controller 130 schedules queues respectively corresponding to the functions and operations assigned with the identifiers, respectively. The controller 130 allocates memory regions corresponding to the respective queues, to the memory 144 included in the controller 130 and the memory included in the host 102. The controller 130 manages the identifiers assigned to the respective functions and operations, the queues scheduled for the respective identifiers and the memory regions allocated to the memory 144 of the controller 130 and the memory of the host 102 in correspondence to the queues, respectively. The controller 130 performs the functions and operations for the memory device 150, through the memory regions allocated to the memory 144 of the controller 130 and the memory of the host 102.

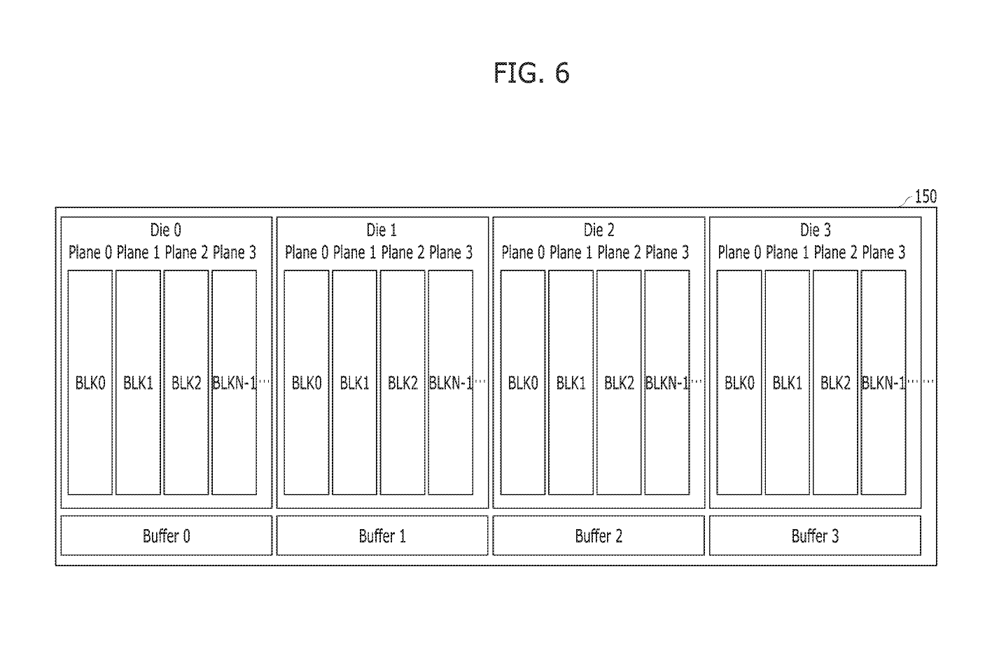

Referring to FIG. 6, the memory device 150 includes a plurality of memory dies, for example, a memory die 0, a memory die 1, a memory die 2, and a memory die 3, and each of the memory dies includes a plurality of planes, for example, a plane 0, a plane 1, a plane 2, and a plane 3. The respective planes in the memory dies included in the memory device 150 may include a plurality of memory blocks, for example, N number of blocks BLK0, BLK1, BLK2 to BLKN−1, each including a plurality of pages, for example, 2\hat{ }M number of pages, as described above with reference to FIG. 2. Moreover, the memory device 150 includes a plurality of buffers corresponding to the respective memory dies, for example, a buffer 0 corresponding to the memory die 0, a buffer 1 corresponding to the memory die 1, a buffer 2 corresponding to the memory die 2 and a buffer 3 corresponding to the memory die 3.

When performing command operations corresponding to a plurality of commands received from the host 102, data corresponding to the command operations are stored in the buffers included in the memory device 150. For example, when performing program operations, data corresponding to the program operations are stored in the buffers, and are then stored in the pages included in the memory blocks of the memory dies. When performing read operations, data corresponding to the read operations are read from the pages included in the memory blocks of the memory dies, are stored in the buffers, and are then provided to the host 102 through the controller 130.

In the embodiment of the present disclosure, although it is described below, as an example for the sake of convenience in explanation, that the buffers included in the memory device 150 exist outside the respective corresponding memory dies, the present invention is not limited thereto. That is, it is to be noted that the buffers may exist inside the respective corresponding memory dies. It is to be noted also that the buffers may correspond to the respective planes or the respective memory blocks in the respective memory dies. Further, in the embodiment of the present disclosure, although it is described below, as an example for the sake of convenience in explanation, that the buffers included in the memory device 150 are the plurality of page buffers 322, 324 and 326 included in the memory device 150 as described above with reference to FIG. 3, it is to be noted that the buffers may be a plurality of caches or a plurality of registers included in the memory device 150.

Furthermore, the plurality of memory blocks included in the memory device 150 may be grouped into a plurality of super memory blocks, and command operations may be performed in the plurality of super memory blocks. Each of the super memory blocks may include a plurality of memory blocks, for example, memory blocks included in a first memory block group and a second memory block group. In this regard, in the case where the first memory block group is included in the first plane of a certain first memory die, the second memory block group may be included in the first plane of the first memory die, be included in the second plane of the first memory die, or be included in the planes of a second memory die.

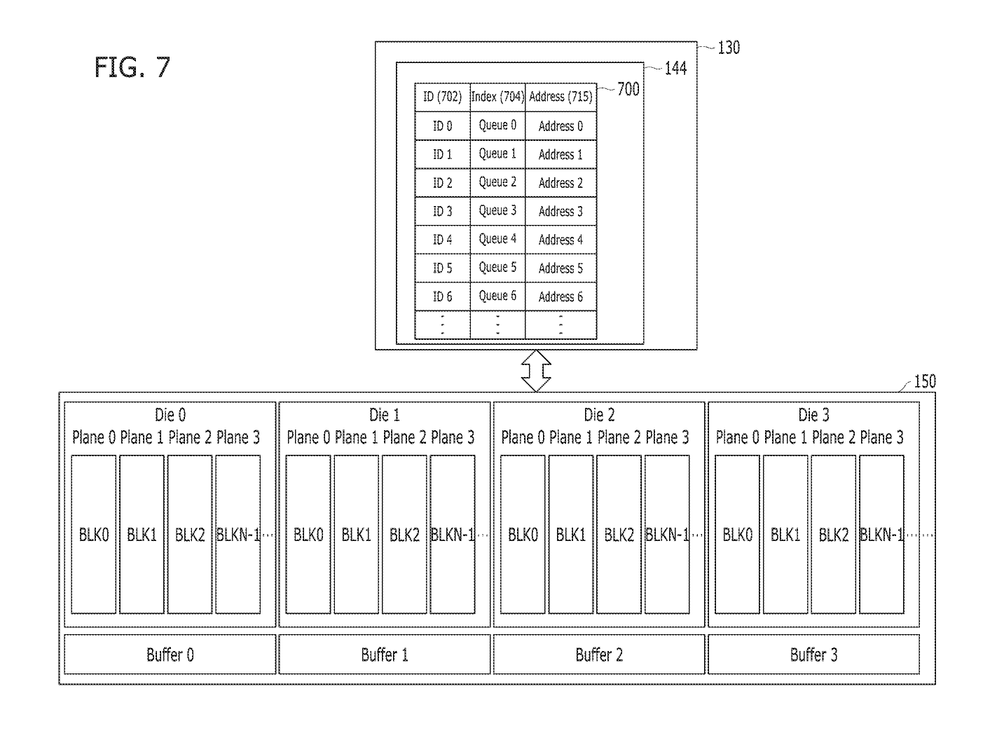

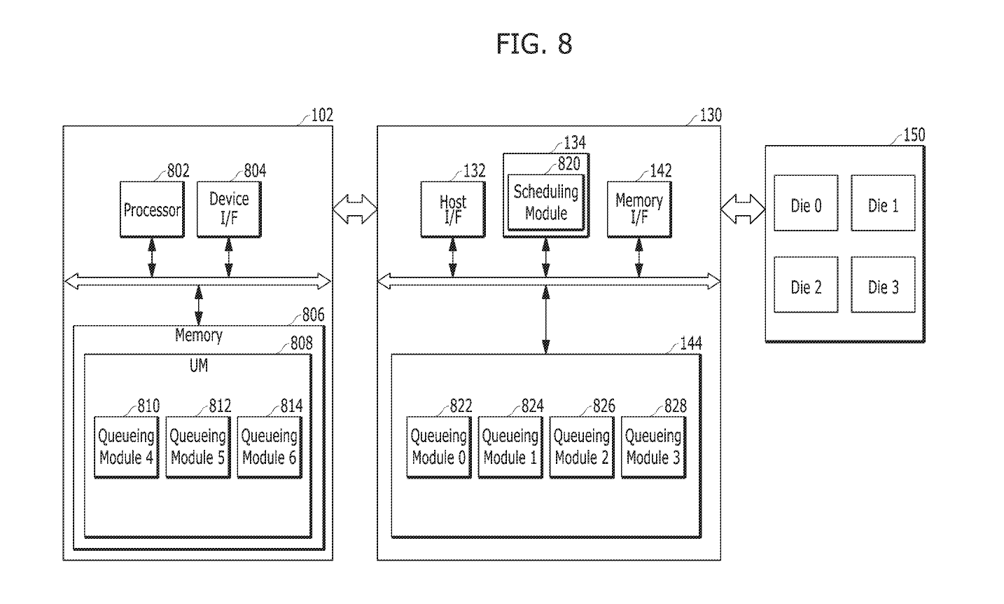

Hereinbelow, detailed descriptions will be made with reference to FIGS. 7 and 8 for, when performing functions and operations including a foreground operation and a background operation for the memory device 150, scheduling of queues corresponding to the respective functions and operations, allocating of memory regions corresponding to the respective queues to the memory 144 of the controller 130 and the memory of the host 102 and performing of the functions and operations through the memory regions corresponding to the respective queues, as described above, in the memory system 110 in accordance with the embodiment of the present disclosure.

Referring to FIG. 7, when performing functions and operations including a foreground operation and a background operation for the plurality of memory blocks included in the memory device 150, after checking the respective functions and operations to be performed in the memory blocks of the memory device 150, the controller 130 assigns identifiers to the respective functions and operations. Particularly, after checking functions and operations that are to use the memory 144 included in the controller 130, the controller 130 assigns respective identifiers (IDs) to the functions and operations that are to use the memory 144 of the controller 130.

The controller 130 schedules queues corresponding to the functions and operations assigned with the respective identifiers, and allocates memory regions corresponding to the respective queues, to the memory 144 of the controller 130 and the memory of the host 102. In this regard, after scheduling the queues corresponding to the functions and operations, the controller 130 assigns virtual addresses to the respective queues, and accesses the respective queues by using the virtual addresses when accessing the respective queues. The controller 130 allocates the memory regions corresponding to the respective queues, to the memory 144 of the controller 130 and the memory of the host 102. The controller 130 performs the functions and operations for the plurality of memory blocks included in the memory device 150, by using the memory regions allocated to the memory 144 of the controller 130 and the memory of the host 102. The memory regions corresponding to the scheduled queues are allocated to the memory 144 of the controller 130 and the memory of the host 102. The controller 130 performs the functions and operations of the memory device 150, by using the queues included in the memory 144 of the controller 130 and the memory of the host 102.

In detail, when performing operations and functions including a foreground operation and a background operation, for the memory blocks included in the memory device 150 after checking the operations and functions to be performed in the memory blocks of the memory device 150, the controller 130 assigns identifiers 702 for the respective operations and functions, and records the identifiers 702 assigned to the respective operations and functions, in a scheduling table 700. The scheduling table 700 may be metadata for the memory device 150. Therefore, the scheduling table 700 is stored in the memory 144 of the controller 130, in particular, the second buffer 520 included in the memory 144 of the controller 130, and may also be stored in the memory device 150.

After scheduling queues corresponding to the operations and functions assigned with the respective identifiers 702, the controller 130 assigns virtual addresses to the respective queues, and records indexes 704 for the respective queues, in the scheduling table 700. The controller 130 allocates memory regions corresponding to the respective queues, to the memory 144 of the controller 130 and the memory of the host 102, and records addresses 715 of the memory regions corresponding to the respective queues, in the scheduling table 700.

The controller 130 maps the virtual addresses assigned to the respective queues and the addresses 715 of the memory regions to which the respective queues are allocated. To perform the operations and functions for the memory blocks of the memory device 150, after checking the identifiers 702 by the respective operations and functions, when accessing the respective corresponding queues through the virtual addresses, the controller 130 converts the virtual addresses corresponding to the respective queues, into the addresses 715 of the memory regions, and performs the functions and operations for the plurality of memory blocks included in the memory device 150, by using the memory regions allocated to the memory 144 of the controller 130 and the memory of the host 102. The controller 130 may include a memory conversion module, a memory management module, or a scheduling module, for example, a scheduling module 820 shown in FIG. 8. The memory conversion module, the memory management module or the scheduling module may convert the virtual addresses corresponding to the respective queues, into the addresses 715 of the memory regions allocated to the memory 144 of the controller 130 and the memory of the host 102.

For instance, when performing command operations, corresponding to the commands received from the host 102, onto the memory blocks of the memory device 150 after checking the command operations corresponding to the commands, respectively, the controller 130 assigns identifiers 702 to the respective command operations, and records the identifiers 702 assigned to the respective command operations, in the scheduling table 700. Herein, it is assumed as an example and for convenience in explanation that ID 0 among the identifiers 702 of the scheduling table 700 is an identifier which indicates program operations among command operations, ID 1 among the identifiers 702 of the scheduling table 700 is an identifier which indicates read operations among command operations, and ID 2 among the identifiers 702 of the scheduling table 700 is an identifier which indicates erase operations among command operations.

After scheduling command operation queues corresponding to the command operations assigned with respective identifiers 702, the controller 130 assigns virtual addresses to the respective command operation queues, and records indexes 704 for the respective command operation queues, in the scheduling table 700. Queue 0 among the indexes 704 of the scheduling table 700 indicates a program task queue corresponding to program operations among command operations, that is, a queue corresponding to ID 0. Queue 1 among the indexes 704 of the scheduling table 700 indicates a read task queue corresponding to read operations among command operations, that is, a queue corresponding to ID 1. Queue 2 among the indexes 704 of the scheduling table 700 indicates an erase task queue corresponding to erase operations among command operations, that is, a queue corresponding to ID 2.

The controller 130 allocates memory regions corresponding to the respective command queues, to the memory 144 of the controller 130 and the memory of the host 102. The controller 130 records the addresses 715 of the memory regions corresponding to the respective command queues, in the scheduling table 700. Address 0 among the addresses 715 of the scheduling table 700 indicates the address of a memory region corresponding to the program task queue for the program operations among command operations, that is, the address of a memory region corresponding to Queue 0. Address 1 among the addresses 715 of the scheduling table 700 indicates the address of a memory region corresponding to the read task queue for the read operations among command operations, that is, the address of a memory region corresponding to Queue 1. Address 2 among the addresses 715 of the scheduling table 700 indicates the address of a memory region corresponding to the erase task queue for the erase operations among command operations, that is, the address of a memory region corresponding to Queue 2.

When performing background operations in the memory blocks of the memory device 150, after checking the background operations to be performed in the memory blocks, the controller 130 assigns identifiers 702 to the background operations. The controller 130 records the identifiers 702 assigned to the respective background operations, in the scheduling table 700. Herein, it is assumed as an example and for convenience in explanation that ID 3 among the identifiers 702 of the scheduling table 700 is an identifier which indicates a map update operation and a map flush operation among background operations, ID 4 among the identifiers 702 of the scheduling table 700 is an identifier which indicates a wear leveling operation as a swap operation among background operations, ID 5 among the identifiers 702 of the scheduling table 700 is an identifier which indicates a garbage collection operation as a copy operation among background operations, and ID 6 among the identifiers 702 of the scheduling table 700 is an identifier which indicates a read reclaim operation as a copy operation among background operations.

After scheduling background operation queues corresponding to the background operations assigned with the respective identifiers 702, the controller 130 assigns virtual addresses to the respective background operation queues, and records indexes 704 for the respective background operation queues, in the scheduling table 700. Queue 3 among the indexes 704 of the scheduling table 700 indicates a map task queue corresponding to the map update operation and the map flush operation among background operations, that is, a queue corresponding to ID 3. Queue 4 among the indexes 704 of the scheduling table 700 indicates a wear leveling task queue corresponding to the wear leveling operation as a swap operation among background operations, that is, a queue corresponding to ID 4. Queue 5 among the indexes 704 of the scheduling table 700 indicates a garbage collection task queue corresponding to the garbage collection operation as a copy operation among background operations, that is, a queue corresponding to ID 5. Queue 6 among the indexes 704 of the scheduling table 700 indicates a read reclaim task queue corresponding to the read reclaim operation as a copy operation among background operations, that is, a queue corresponding to ID 6.

The controller 130 allocates memory regions corresponding to the respective background operation queues, to the memory 144 of the controller 130 and the memory of the host 102. The controller 130 records the addresses 715 of the memory regions corresponding to the respective background operation queues, in the scheduling table 700. Address 3 among the addresses 715 of the scheduling table 700 indicates the address of a memory region corresponding to the map task queue for the map update operation and the map flush operation among background operations, that is, the address of a memory region corresponding to Queue 3. Address 4 among the addresses 715 of the scheduling table 700 indicates the address of a memory region corresponding to the wear leveling task queue for the wear leveling operation among background operations, that is, the address of a memory region corresponding to Queue 4. Address 5 among the addresses 715 of the scheduling table 700 indicates the address of a memory region corresponding to the garbage collection task queue for the garbage collection operation among background operations, that is, the address of a memory region corresponding to Queue 5. Address 6 among the addresses 715 of the scheduling table 700 indicates the address of a memory region corresponding to the read reclaim task queue for the read reclaim operation among background operations, that is, the address of a memory region corresponding to Queue 6.

In the embodiment of the present disclosure, although it is described, as an example for the sake of convenience in explanation, that for the same types of operations and functions, a single identifier is assigned, a single queue is scheduled, and a single memory region is allocated, the present invention is not limited thereto. That is, it is to be noted that the present disclosure may be applied in the same manner even in the case where, for the same types of operations and functions, multiple identifiers are assigned, multiple queues are scheduled, and multiple memory regions are allocated. For example, the controller 130 may assign ID 0 for a first program operation among program operations, schedule Queue 0, and allocate the memory region of Address 0. The controller 130 may assign ID 1 for a second program operation among the program operations, schedule Queue 1 and allocate the memory region of Address 1. In other words, in the memory system in accordance with the embodiment of the present disclosure, the controller 130 may assign respective identifiers depending on operations and functions to be performed in the memory device 150, dynamically schedule queues corresponding to the operations and functions assigned with the respective identifiers. The controller 130 may dynamically allocate memory regions corresponding to the respective queues, to the memory 144 of the controller 130 and the memory of the host 102.

In the embodiment of the present disclosure, although it is described, as an example for the sake of convenience in explanation, that after the controller 130 schedules queues corresponding to operations and functions to be performed in the memory blocks of the memory device 150, memory regions corresponding to the respective queues are allocated to the memory 144 of the controller 130 and the memory of the host 102, the present invention is not limited thereto. That is, it is to be noted that the disclosure may be applied in the same manner even in the case where the host 102 allocates memory regions corresponding to the respective queues to the memory of the host 102 by the request of the controller 130. For example, after checking foreground operations and background operations to be performed in the memory blocks of the memory device 150, as described above, the controller 130 performs the foreground operations and the background operations in the memory blocks of the memory device 150 by using the memory regions allocated to the memory 144 of the controller 130 and the memory of the host 102. The controller 130 transmits a response message or a response signal to the host 102, in correspondence to performing of the foreground operations and the background operations.

In correspondence to performing of the foreground operations and the background operations, in the case where data to be provided from the controller 130 to the host 102 (hereinafter, referred to as ‘host data’) exists in the memory 144 of the controller 130 or the memory device 150, the controller 130 notifies the host 102 through the response message or the response signal that the host data exists. In the response message or the response signal for notifying that the host data exists, there may be included an information on the type of the host data and an information on the size of the host data. After allocating memory regions for the host data to the memory of the host 102 in correspondence to the message or the signal received from the controller 130, the host 102 transmits a read command to the controller 130 and receives the host data from the controller 130 as a response to the read command.

The host 102 transmits, to the controller 130, a read buffer command as a read command for reading the host data existing in the memory 144 of the controller 130 or the memory device 150, and receives, from the controller 130, a response packet as a response to the read buffer command. In the response packet, the host data in the memory 144 of the controller 130 or the memory device 150 is included, in particular, the user data or metadata stored in the memory 144 of the controller 130 is included. The response message or the response packet may include a header area and a data area. The information on the type of the host data may be included in the type field of the header area, the information on the size of the host data may be included in the length field of the header area, and the host data corresponding to the header area may be included in the data area of the response packet. The host 102 stores the host data received from the controller 130 through the response packet, in the memory regions allocated to the memory of the host 102. When receiving, from the controller 130, an update message or an update signal for host data, the host 102 transmits a read buffer command to the controller 130, receives updated host data from the controller 130 and then stores the received updated host data in the memory regions allocated to the memory of the host 102.

In particular, when performing, in the memory blocks of the memory device 150, program operations, read operations or erase operations as command operations or performing a wear leveling operation, a garbage collection operation or a read reclaim operation as background operations, the controller 130 performs a map update operation and a map flush operation in correspondence to performing of the command operations and background operations. The controller 130 provides, to the host 102, the map data stored in the memory 144 of the controller 130, as a host performance booster (HPB) for improving not only the operational performance of the memory system 110 but also the operational performance of the host 102. Specifically, as described above, the controller 130 provides updated map data to the host 102 in correspondence to performing of the command operations or the background operations. Accordingly, host data becomes map data. After transmitting, to the host 102, a response message or a response signal in which the type information and size information of the map data are included, the controller 130 transmits a response packet in which the map data is included, to the host 102, according to the read buffer command received from the host 102. The controller 130 provides, to the host 102, first map data in correspondence to performing of the command operations or background operations. In particular, when an update operation for first map data is performed, the controller 130 provides updated first map data to the host 102. Therefore, the updated first map data is buffered and cached in the memory of the host 102.

As described above, after transmitting host data to the host 102, in correspondence to that the host data is stored in the memory regions allocated to the memory of the host 102, the controller 130 assigns an identifier for the transmitting and storing of the host data (hereinafter, referred to as a ‘host data operation’), schedules a host data queue corresponding to the host data operation, assigns a virtual address to the host data queue, and checks the address of the memory regions allocated to the memory of the host 102 for the host data queue. The controller 130 records the identifier for the host data operation, an index for the host data queue and the address of the memory regions corresponding to the host data queue, in the scheduling table 700. Hereinbelow, detailed descriptions will be made with reference to FIG. 8 for a case where the controller 130 performs a foreground operation and a background operation in the memory blocks of the memory device 150 according to the identifiers 720, the indexes 704 and the addresses 715 recorded in the scheduling table 700, in the memory system in accordance with the embodiment of the disclosure.

Referring to FIG. 8, when performing foreground operations and background operations in the memory blocks of the memory device 150, after scheduling queues, through a scheduling module 820, corresponding to the respective foreground operations and background operations, according to the identifiers 702, the indexes 704 and the addresses 715 recorded in the scheduling table 700, the controller 130 allocates memory regions corresponding to the respective queues, to the memory 144 of the controller 130 and a memory 806 of the host 102. Thus, the queuing modules (for example, queueing modules 0 to 6 shown in FIG. 8) of the queues corresponding to the respective foreground operations and background operations may be included in the memory 144 of the controller 130 and the memory 806 of the host 102.

The scheduling module 820 may be implemented through the processor 134 of the controller 130. Accordingly, the scheduling module 820 may be included in the processor 134 of the controller 130, and an operation to be performed by the scheduling module 820 may be performed in the processor 134, in particular, through the flash translation layer (FTL). The scheduling module 820 may perform checking of operations and functions to be performed in the memory blocks of the memory device 150, assigning identifiers 702, scheduling corresponding queues and allocating of memory regions.

When the controller 30 performs a foreground operation and a background operation for the memory blocks of the memory device 150, the queuing modules become memory regions in the memory 144 of the controller 130 and the memory 806 of the host 102 in which data corresponding to the respective foreground operation and background operation are stored. A queuing module 0, a queuing module 1, a queuing module 2 and a queuing module 3 included in the memory 144 of the controller 130 become the buffers or caches included in the memory 144 of the controller 130. A queuing module 4, a queuing module 5 and a queuing module 6 included in the memory 806 of the host 102 become a unified memory (UM) 808 included in the memory 806 of the host 102.

The host 102 may include a processor 802, the memory 806 and a device interface 804. The processor 802 of the host 102 controls the general operations of the host 102. In particular, the processor 802 of the host 102 controls commands corresponding to user requests, to be transmitted to the controller 130 of the memory system 110, such that command operations corresponding to the user requests are performed in the memory system 110. The processor 802 of the host 102 may be embodied by a microprocessor or a central processing unit (CPU). When it is checked through the response message or the response signal received from the controller 130 that host data exists, after allocating memory regions for the host data, to the UM 808 included in the memory 806 of the host 102, the processor 802 of the host 102 transmits a read command to the controller 130, and stores the host data received through a response packet from the controller 130, in the memory regions allocated to the UM 808.

The memory 806 of the host 102 may be the main memory or the system memory of the host 102 stores data for the driving of the host 102, including a host-use memory region (not shown) in which data in the host 102 are stored and a device-use memory region in which data in the memory system 110 are stored.

In the host-use memory region, which may be a system memory region in the memory 806 of the host 102, there are stored data or program information on the system of the host 102, for example, a file system or an operating system. In the UM 808, which may be the device-use memory region in the memory 806 of the host 102, there are stored data or information in the memory system 110 in the case where the memory system 110 performs command operations corresponding to the commands received from the host 102, that is, a foreground operation or a background operation. The memory 806 of the host 102 may be embodied by a volatile memory, for example, a static random access memory (SRAM) or a dynamic random access memory (DRAM). In addition, in the memory 806 of the host 102, the UM 808 may determine that the memory device 110 is in the power-on state after the memory system 110 is powered-off during a booting operation, and the UM 808 may be allocated and reported to the memory system 110 as a device-use memory region.

The device interface 804 of the host 102, which may be a host controller interface (HCI), processes the commands and data of the host 102, and may be configured to communicate the memory system 110 through at least one of various interface protocols such as a universal serial bus (USB), multimedia card (MMC), peripheral component interconnection-express (PCI-e or PCIe), small computer system interface (SCSI), serial-attached SCSI (SAS), serial advanced technology attachment (SATA), parallel advanced technology attachment (PATH), enhanced small disk interface (ESDI), integrated drive electronics (IDE), and mobile industry processor interface (MIPI).

Although FIG. 8 shows, for the sake of convenience in explanation, that memory regions of seven queuing modules corresponding to respective foreground operations and background operations are allocated to the memory 144 of the controller 130 and the UM 808 of the host 102, it is to be noted that the present invention is not limited thereto. That is, memory regions of varying number of queuing modules may be allocated to the memory 144 of the controller 130 and the UM 808 of the host 102 in correspondence to the respective foreground operations and background operations to be performed in the memory blocks of the memory device 150.

For example, when performing program operations in the memory blocks of the memory device 150, the controller 130 assigns ID 0 for the program operations, schedules Queue 0, and allocates the memory region of Address 0. The memory region of Address 0 corresponding to Queue 0 is allocated to the memory 144 of the controller 130, and accordingly, the queuing module 0 corresponding to Queue 0 is included in the memory 144 of the controller 130. In the queuing module 0, there are stored data corresponding to the program operations when performing the program operations in the memory blocks of the memory device 150.

When performing read operations in the memory blocks of the memory device 150, the controller 130 may assign ID 1 for the read operations, schedule Queue 1 and allocate the memory region of Address 1. The memory region of Address 1 corresponding to Queue 1 is allocated to the memory 144 of the controller 130. Accordingly, the queuing module 1 corresponding to Queue 1 is included in the memory 144 of the controller 130. In the queuing module 1, there are stored data corresponding to the read operations when performing the read operations in the memory blocks of the memory device 150.

When performing erase operations in the memory blocks of the memory device 150, the controller 130 may assign ID 2 for the erase operations, schedule Queue 2 and allocate the memory region of Address 2. The memory region of Address 2 corresponding to Queue 2 is allocated to the memory 144 of the controller 130. Accordingly, the queuing module 2 corresponding to Queue 2 is included in the memory 144 of the controller 130. In the queuing module 2, there are stored data corresponding to the erase operations when performing the erase operations in the memory blocks of the memory device 150.

When performing a map update operation and a map flush operation in the memory blocks of the memory device 150, the controller 130 may assign ID 3 for the map update operation and the map flush operation, schedules Queue 3 and allocates the memory region of Address 3. The memory region of Address 3 corresponding to Queue 3 is allocated to the memory 144 of the controller 130. Accordingly, the queuing module 3 corresponding to Queue 3 is included in the memory 144 of the controller 130. In the queuing module 3, there are stored data corresponding to the map update operation and the map flush operation when performing the map update operation and the map flush operation in the memory blocks of the memory device 150.

When performing a wear leveling operation in the memory blocks of the memory device 150, the controller 130 may assign ID 4 for the wear leveling operation, schedules Queue 4 and allocates the memory region of Address 4. The memory region of Address 4 corresponding to Queue 4 is allocated to the UM 808 of the host 102, and accordingly, the queuing module 4 corresponding to Queue 4 is included in the UM 808 of the host 102. In the queuing module 4, there is stored data corresponding to the wear leveling operation when performing the wear leveling operation in the memory blocks of the memory device 150.

When performing a garbage collection operation in the memory blocks of the memory device 150, the controller 130 may assign ID 5 for the garbage collection operation, schedules Queue 5 and allocates the memory region of Address 5. The memory region of Address 5 corresponding to Queue 5 is allocated to the UM 808 of the host 102. Accordingly, the queuing module 5 corresponding to Queue 5 is included in the UM 808 of the host 102. In the queuing module 5, there is stored data corresponding to the garbage collection operation when performing the garbage collection operation in the memory blocks of the memory device 150.

When performing a read reclaim operation in the memory blocks of the memory device 150, the controller 130 may assign ID 6 for the read reclaim operation, schedules Queue 6 and allocate the memory region of Address 6. The memory region of Address 6 corresponding to Queue 6 is allocated to the UM 808 of the host 102. Accordingly, the queuing module 6 corresponding to Queue 6 is included in the UM 808 of the host 102. In the queuing module 6, there is stored data corresponding to the read reclaim operation when performing the read reclaim operation in the memory blocks of the memory device 150.

When the controller 130 performs a host data operation with the host 102, after transmitting a response message or a response signal in which an information on the type of host data and an information on the size of the host data are included, to the host 102, the controller 130 transmits a response packet in which the host data is included into the host 102, according to a read buffer command received from the host 102. Further, after assigning an identifier for the host data operation, the controller 130 schedules a host data queue, and checks the address of a memory region allocated to the UM 808 of the host 102 for the host data queue. The memory region corresponding to the host data queue is allocated by the host 102 to the UM 808 of the host 102 in correspondence to the response message or the response signal received from the controller 130. Accordingly, a queuing module corresponding to the host data queue is included in the UM 808 of the host 102. In the queuing module corresponding to the host data queue, the host data is stored. Particularly, updated map data is stored in correspondence to the foreground operations and background operations performed in the memory blocks of the memory device 150.

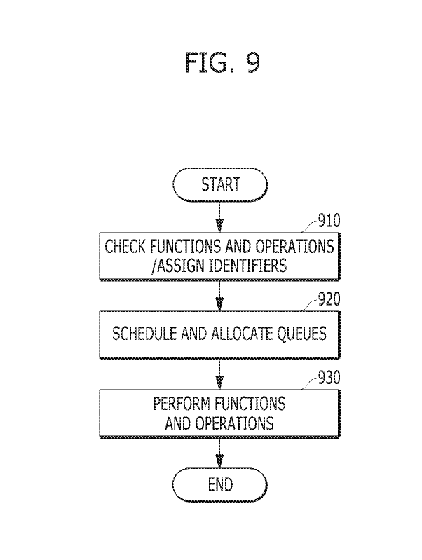

As is apparent from the above descriptions, in the memory system in accordance with the embodiment of the present disclosure, when performing foreground operations and background operations to be performed in the memory blocks of the memory device 150, after assigning respective identifiers for operations and functions to be performed in the memory blocks of the memory device 150, the controller 130 schedules queues corresponding to the operations and functions, allocates memory regions corresponding to the respective queues, to the memory 144 of the controller 130 and the UM 808 of the host 102, and performs the foreground operations and background operations in the memory blocks of the memory device 150 through the memory regions allocated to the memory 144 of the controller 130 and the UM 808 of the host 102. In the memory system in accordance with the embodiment of the present disclosure, operational performances in not only the memory system but also the host 102 may be improved, and the utilization efficiency of a memory may be improved by extending the memory 144 of the controller 130 to the host 102. Hereinbelow, an operation for processing data in a memory system in accordance with an embodiment will be described below in detail with reference to FIG. 9.

FIG. 9 is a flow chart describing an operation process for processing data in a memory system in accordance with an embodiment.

Referring to FIG. 9, at step 910, the memory system 110 checks operations and functions including a foreground operation and a background operation to be performed in the memory blocks of the memory device 150. The memory system 110 assigns identifiers to the respective operations and functions.

At step 920, the memory system 110 schedules queues corresponding to the operations and functions assigned with the respective identifiers, assigns virtual addresses for the respective queues, and allocates, for memory regions corresponding to the respective queues, some of the memory 144 of the controller 130 and the UM 808 of the host 102. The memory system 110 records the identifiers assigned for the respective operations and functions, indexes for the respective queues and the addresses of the memory regions corresponding to the respective queues, in the scheduling table 700, and the scheduling table 700 is included and stored in metadata.

At step 930, the memory system 110 performs the respective operations and functions including foreground operations and background operations through the memory regions allocated to the memory 144 of the controller 130 and the UM 808 of the host 102.

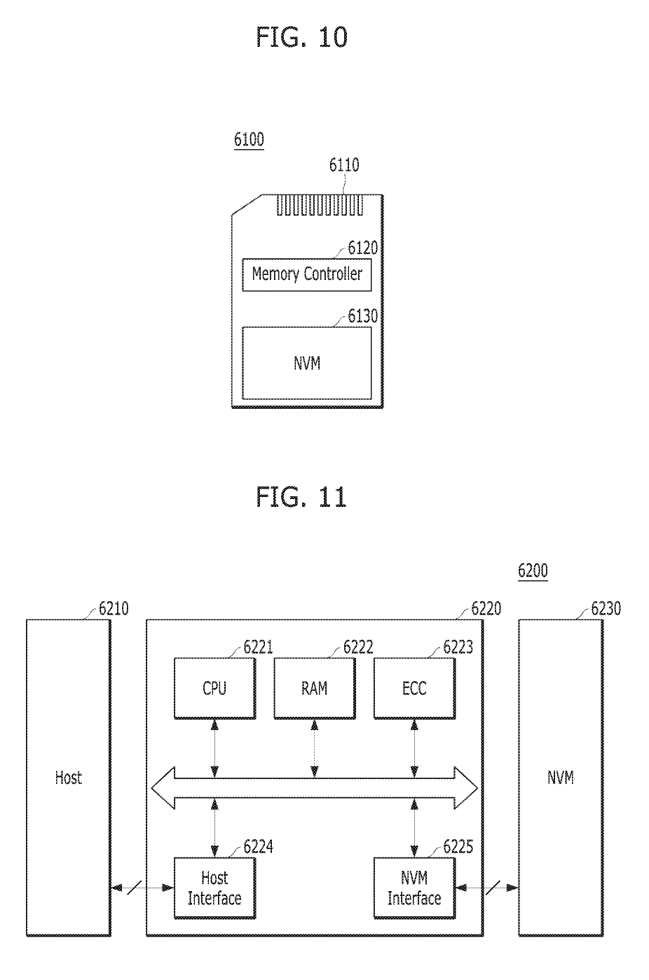

Since detailed descriptions were made above with reference to FIGS. 5 to 8 for, when performing operations including foreground operations and background operations and functions in the memory blocks of the memory device 150, assigning identifiers to the respective operations and functions, scheduling corresponding queues, allocating memory regions corresponding to the respective queues and then performing the operations including foreground operations and background operations and the functions, further descriptions thereof will be omitted herein. Hereinbelow, detailed descriptions will be made with reference to FIGS. 10 to 18, for a data processing system and electronic appliances to which the memory system 110 including the memory device 150 and the controller 130 described above with reference to FIGS. 1 to 9, in accordance with the embodiment of the disclosure, is applied.

FIGS. 10 to 18 are diagrams schematically illustrating application examples of the data processing system of FIG. 1.

FIG. 10 is a diagram schematically illustrating another example of the data processing system including the memory system in accordance with the embodiment. FIG. 10 schematically illustrates a memory card system to which the memory system in accordance with the embodiment is applied.

Referring to FIG. 10, the memory card system 6100 may include a memory controller 6120, a memory device 6130 and a connector 6110.

The memory controller 6120 may be connected to the memory device 6130 embodied by a nonvolatile memory. The memory controller 6120 may be configured to access the memory device 6130. By way of example and not limitation, the memory controller 6120 may be configured to control read, write, erase and background operations of the memory device 6130. The memory controller 6120 may be configured to provide an interface between the memory device 6130 and a host, and use a firmware for controlling the memory device 6130. That is, the memory controller 6120 may correspond to the controller 130 of the memory system 110 described with reference to FIGS. 1 and 5, and the memory device 6130 may correspond to the memory device 150 of the memory system 110 described with reference to FIGS. 1 and 5.

Thus, the memory controller 6120 may include a RAM, a processing unit, a host interface, a memory interface and an error correction component. The memory controller 130 may further include the elements shown in FIG. 5.

The memory controller 6120 may communicate with an external device, for example, the host 102 of FIG. 1 through the connector 6110. For example, as described with reference to FIG. 1, the memory controller 6120 may be configured to communicate with an external device under one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 5.

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., a SM and a SMC), a memory stick, a multimedia card (e.g., a MMC, a RS-MMC, a MMCmicro and an eMMC), an SD card (e.g., a SD, a miniSD, a microSD and a SDHC) and a universal flash storage (UFS).

FIG. 11 is a diagram schematically illustrating another example of the data processing system including the memory system in accordance with the embodiment.

Referring to FIG. 11, the data processing system 6200 may include a memory device 6230 having one or more nonvolatile memories and a memory controller 6220 for controlling the memory device 6230. The data processing system 6200 illustrated in FIG. 11 may serve as a storage medium such as a memory card (CF, SD, micro-SD or the like) or USB device, as described with reference to FIG. 1. The memory device 6230 may correspond to the memory device 150 in the memory system 110 illustrated in FIGS. 1 and 5. The memory controller 6220 may correspond to the controller 130 in the memory system 110 illustrated in FIGS. 1 and 5.

The memory controller 6220 may control a read, write or erase operation on the memory device 6230 in response to a request of the host 6210. The memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221. The RAM 6222 may be used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC component 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224. The memory controller 6220 may transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. Particularly, as the memory controller 6220 is configured to communicate with the external device through one or more of various communication protocols, the memory system and the data processing system in accordance with the present embodiment may be applied to wired/wireless electronic devices or particularly a mobile electronic device.

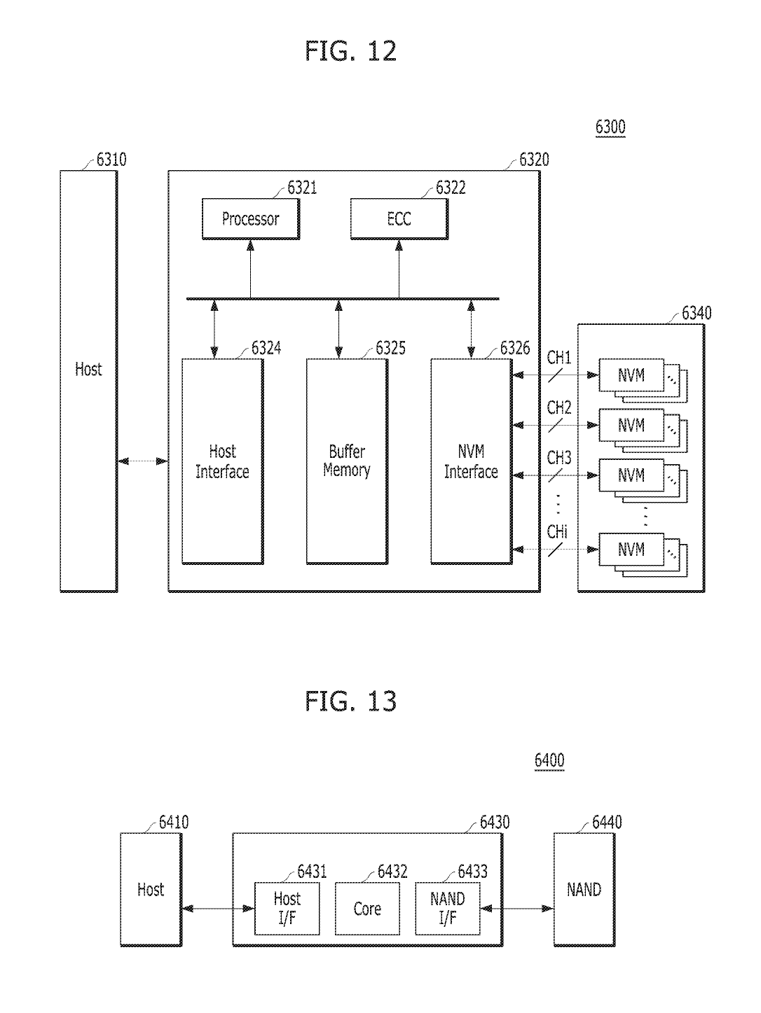

FIG. 12 is a diagram schematically illustrating another example of the data processing system including the memory system in accordance with the embodiment. FIG. 12 schematically illustrates an SSD to which the memory system in accordance with the embodiment is applied.

Referring to FIG. 12, the SSD 6300 may include a controller 6320 and a memory device 6340 including a plurality of nonvolatile memories. The controller 6320 may correspond to the controller 130 in the memory system 110 of FIGS. 1 and 5. The memory device 6340 may correspond to the memory device 150 in the memory system of FIGS. 1 and 5.

More specifically, the controller 6320 may be connected to the memory device 6340 through a plurality of channels CHI to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR

SDRAM, LPDDR SDRAM and GRAM or nonvolatile memories such as FRAM, ReRAM, STT-MRAM and PRAM. For convenience of description, FIG. 11 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation. The ECC circuit 6322 may perform an error correction operation on data read from the memory device 6340 based on the ECC value during a read operation. The ECC circuit 6322 may perform an error correction operation on data recovered from the memory device 6340 during a failed data recovery operation.

The host interface 6324 may provide an interface function with an external device, for example, the host 6310. The nonvolatile memory interface 6326 may provide an interface function with the memory device 6340 connected through the plurality of channels.

Furthermore, a plurality of SSDs 6300 to which the memory system 110 of FIGS. 1 and 5 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300. The RAID controller may output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300. The RAID controller may provide data read from the selected SSDs 6300 to the host 6310.

FIG. 13 is a diagram schematically illustrating another example of the data processing system including the memory system in accordance with the embodiment. FIG. 13 schematically illustrates an embedded Multi-Media Card (eMMC) to which the memory system in accordance with the embodiment is applied.

Referring to FIG. 13, the eMMC 6400 may include a controller 6430 and a memory device 6440 embodied by one or more NAND flash memories. The controller 6430 may correspond to the controller 130 in the memory system 110 of FIGS. 1 and 5. The memory device 6440 may correspond to the memory device 150 in the memory system 110 of FIGS. 1 and 5.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400. The host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

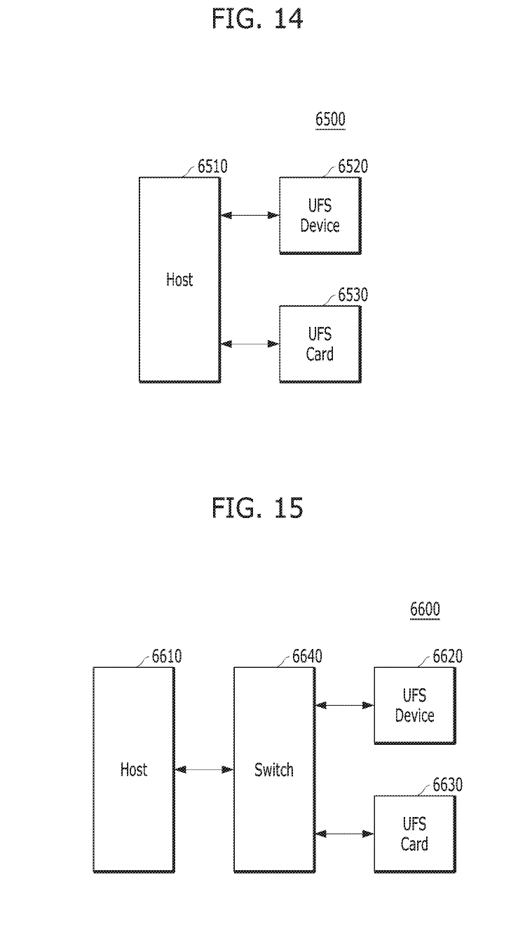

FIGS. 14 to 17 are diagrams schematically illustrating other examples of the data processing system including the memory system in accordance with the embodiment. FIGS. 14 to 17 schematically illustrate UFS (Universal Flash Storage) systems to which the memory system in accordance with the embodiment is applied.

Referring to FIGS. 14 to 17, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in FIGS. 1 and 5. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 11 to 13, and the UFS cards 6530, 6630, 6730, 6830 may be embodied in the form of the memory card system 6100 described with reference to FIG. 10.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, for example, an UFDs, a MMC, a SD, a mini-SD, and a micro-SD.

In the UFS system 6500 illustrated in FIG. 14, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410. The form of a star is a sort of arrangements where a single centralized component is coupled to plural devices for parallel processing. A plurality of UFS cards may be connected in parallel or in the form of a star to the UFS device 6520 or connected in series or in the form of a chain to the UFS device 6520.

In the UFS system 6600 illustrated in FIG. 15, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and

UFS cards may be connected in parallel or in the form of a star to the switching module 6640, and a plurality of UFS cards may be connected in series or in the form of a chain to the UFS device 6620.

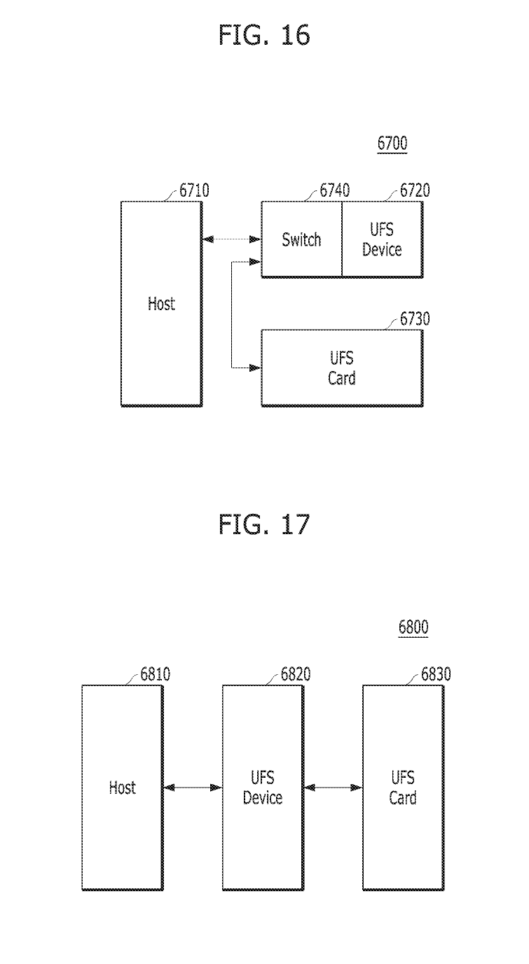

In the UFS system 6700 illustrated in FIG. 16, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 17, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

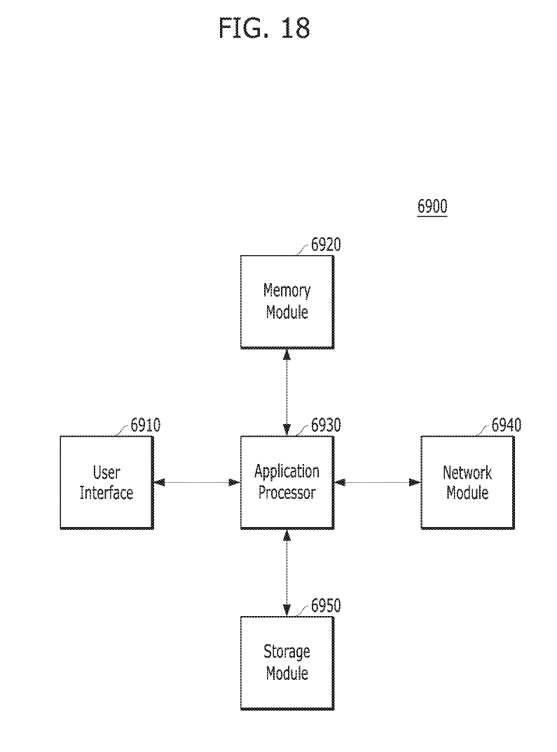

FIG. 18 is a diagram schematically illustrating another example of the data processing system including the memory system in accordance with an embodiment of the present invention. FIG. 18 is a diagram schematically illustrating a user system to which the memory system in accordance with the embodiment is applied.

Referring to FIG. 18, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, a NOR flash and a 3D NAND flash, and provided as a removable storage medium such as a memory card or external drive of the user system 6900. The storage module 6950 may correspond to the memory system 110 described with reference to FIGS. 1 and 5. Furthermore, the storage module 6950 may be embodied as an SSD, an eMMC and an UFS as described above with reference to FIGS. 12 to 17.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIGS. 1 and 5 is applied to a mobile electronic device of the user system 6900, the application processor 6930 may control overall operations of the mobile electronic device. The network module 6940 may serve as a communication module for controlling wired/wireless communication with an external device. The user interface 6910 may display data processed by the processor 6930 on a display/touch module of the mobile electronic device. Further, the user interface 6910 may support a function of receiving data from the touch panel.

The memory system and the operating method thereof according to the embodiments may minimize complexity and performance deterioration of the memory system and maximize utilization efficiency of a memory device, thereby quickly and stably process data with respect to the memory device.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a memory device including a plurality of pages in which data are stored and a plurality of memory blocks in which the pages are included; and
a controller including a first memory,
wherein the controller checks operations to be performed in the memory blocks, schedules queues corresponding to the operations, allocates the first memory and a second memory included in a host to memory regions corresponding to the scheduled queues, performs the operations through the memory regions allocated in the first memory and the second memory, and records information on the operations, the queues and the memory regions in a table.

2. The memory system according to claim 1, wherein the controller records, after assigning identifiers for the operations, the respective identifiers in the table.

3. The memory system according to claim 1, wherein the controller records, after assigning virtual address to the queues, respective indexes for the queues in the table.

4. The memory system according to claim 3, wherein the controller records addresses of the memory regions allocated to the first memory and the second memory, in the table, and maps the virtual addresses and the addresses of the memory regions.

5. The memory system according to claim 4, wherein the controller converts, when accessing the queues through the virtual addresses, the virtual addresses into the addresses of the memory regions.

6. The memory system according to claim 1,
wherein the controller checks host data in correspondence to performing of the operations, and transmits a response message which includes an indication information of the host data, to the host, and
wherein the indication information includes an information on a type of the host data and an information on a size of the host data.

7. The memory system according to claim 6, wherein the host checks the indication information included in the response message, allocates a memory region for the host data, to the second memory, in correspondence to the indication information, and transmits a read command for the host data, to the controller.

8. The memory system according to claim 7,
wherein the controller transmits the host data to the host as a response to the read command, and
wherein the host data includes at least one of user data and map data in correspondence to performing of the operations, and is stored in the memory region of the host data which is allocated to the second memory.

9. The memory system according to claim 8, wherein the controller assigns an identifier for transmission and storage of the host data, stores the identifier in the table, schedules a host data queue corresponding to the host data, records an index for the host data queue, in the table, checks an address for the memory region of the host data, allocated to the second memory, and records the address for the memory region of the host data, in the table.

10. The memory system according to claim 8, wherein the controller updates the host data, transmits an update message for the host data, to the host, and transmits updated host data to the host after receiving the read command from the host in correspondence to the update message.

11. A method for operating a memory system, comprising:
checking, for a memory device including a plurality of pages in which data are stored and a plurality of memory blocks in which the pages are included, operations to be performed in the memory blocks;
scheduling queues corresponding to the operations;
allocating a first memory included in a controller and a second memory included in a host to memory regions corresponding to the scheduled queues;
performing the operations through the memory regions allocated in the first memory and the second memory; and
recording information on the operations, the queues and the memory regions in a table.

12. The method according to claim 11, wherein the recording comprises:
recording, after assigning identifiers for the operations, the respective identifiers in the table.

13. The method according to claim 11, wherein the recording comprises:
recording, after assigning virtual address to the queues, respective indexes for the queues in the table.

14. The method according to claim 13, wherein the recording comprises:
recording addresses of the memory regions allocated to the first memory and the second memory, in the table.

15. The method according to claim 14, further comprising:
mapping the virtual addresses and the addresses of the memory regions; and
converting, when accessing the queues through the virtual addresses, the virtual addresses into the addresses of the memory regions.

16. The method according to claim 11, further comprising:
checking host data in correspondence to performing of the operations; and
transmitting a response message which includes an indication information of the host data, to the host.

17. The method according to claim 16, further comprising:
receiving, after a memory region for the host data is allocated to the second memory, in correspondence to the indication information included in the response message, a read command for the host data, from the host; and
transmitting the host data to the host as a response to the read command.

18. The method according to claim 17,
wherein the memory region for the host data is allocated to the second memory by the host,
wherein the indication information includes an information on a type of the host data and an information on a size of the host data, and
wherein the host data includes at least one of user data and map data in correspondence to performing of the operations, and is stored in the memory region of the host data which is allocated to the second memory.

19. The method according to claim 18, the recording comprises:
assigning an identifier for transmission and storage of the host data, and storing the identifier in the table;
scheduling a host data queue corresponding to the host data, and recording an index for the host data queue, in the table; and
checking an address for the memory region of the host data, allocated to the second memory, and recording the address for the memory region of the host data, in the table.

20. The method according to claim 18, further comprising:
updating the host data, and transmitting an update message for the host data, to the host; and
transmitting updated host data to the host after receiving the read command from the host in correspondence to the update message.
